(19) United States
(12) Patent Application Publication
(10) Pub. No.: US 2010/0018071 A1
(43) Pub. Date: Jan. 28, 2010

(54) Clothes dryer lint filter device

(76) Inventor: Donald E. McKinley, Gainesville, TX (US)

Correspondence Address: Donald E. McKinley, 1 Old Mill Circle, Gainesville, TX, 76240, US

(21) Appl. No.: 12/220,670

(22) Filed: Jul. 28, 2008

(51) Int. Cl. F26B 21/00

(52) U.S. Cl. 34/82

(57) ABSTRACT

A filter mechanism is disclosed which is designed to be used with a clothes drying machine for filtering the exhaust of the clothes drying machine, and for directing said exhaust either into the interior of a building or to the exterior of a building. The mechanism includes a disposable flexible filter element, a cylindrical body that supports and holds in place the flexible filter element, a rectangular enclosure to contain the cylindrical body and filter, and a means of directing the exhausted air into the interior or to the exterior of a building. The cylindrical body, in addition to holding the filter element in place, comprises one end of the rectangular filter mechanism and provides a means of removing the filter element for replacing of the flexible filter element. This said end comprises the inlet to the filter which may be connected the clothes drying machine. Openings on the rectangular housing provide the means for directing the exhaust into the interior or to the exterior of the building. The rectangular housing may be mounted in many positions attached to a wall or other convenient object, or it may be set on the floor.

### BACKGROUND OF THE INVENTION

1. Field of the Invention

The present invention relates generally to the fields of clothes dryer filters and vents, and more specifically, is directed to a means of both further filtering the clothes dryer exhaust and directing the warm, humid exhaust either to the exterior of a building or into the interior of a building.

2. Description of Prior Art

Clothes drying machines typically use an electrical heating element or gas burners to provide heat that is directed into a rotating drum that distributes the heated air across the wet clothing. After the heated air is forced into the drum and across the clothes, it is directed into the dryer exhaust vent for removal to the exterior of the clothes drying machine, along with lint and dust particles. Many devices already in existence handle the dryer exhaust. Some require water to trap the lint and dust particles. Others contain many parts that may be subject to maintenance issues. Still others filter the dryer exhaust and direct it only to the interior of a building, which may be undesirable during Summer months. Yet others contain multiple filtering elements, which may cause increased maintenance time and cost issues.

U.S. Pat. No. 4,183,150, filed Oct. 21, 1976 by Robert B. Nash discloses an electric clothes dryer heater that directs the dryer exhaust to a filter element consisting of a bag which is inflated by the flowing exhaust gas and directs the filtered gas only to the interior of the building. U.S. Pat. No. 3,999,304, filed Jul. 18, 1975 by Edward E. Doty discloses a clothes dryer filter and exhaust system which contains multiple filter elements, has moving parts which if improperly adjusted, may restrict the exhaust flow to the point where the heating element may be damaged, and which exhausts the airflow into the interior of a building only. U.S. Pat. No. 4,395,831, filed Mar. 18, 1977 by Edward G.

Nielson discloses a dryer vent which may direct the unfiltered exhaust to the exterior of a building, or alternatively to the interior of a building. When directed to the interior of a building, the filtered exhaust blows from the direction of the rear of the dryer towards the front of the dryer at a height which would blow the air into the face of a person standing in front of the dryer. U.S. Pat. No. 4,338,731, filed Sep. 22, 1980 by Sidney J. Shames and Harold Shames discloses a vent for a clothes dryer has moving parts which may become unreliable due to accumulation of lint and dust. U.S. Pat. No. 5,210,960, filed Sep. 20, 1989 by Robert Walsh discloses a filter and humidifier that users a water container, which may cause issues with water spillage and cleaning problems.

### SUMMARY OF THE INVENTION

It is an objective of the present invention to provide a clothes dryer lint filter which may be mounted on a wall adjacent to the dryer, or on the floor near the clothes dryer.

It is a further objective of the present invention that the filtered exhaust gas may be directed to the exterior of a building, or to the interior of a building. In one embodiment, this is accomplished by having one of two “knockouts” left in place and the other removed which will allow the exhaust to follow only one path. If it is desired to redirect the exhaust, the open knockout may be plugged by either a sliding gate device, or a simple press in plug, and the remaining knockout may be removed.

It is again a further objective of the present invention to provide a filter element with a comparatively large surface area for the space used.

It is yet a further objective of the present invention that the filter element will be disposable, and may be easily removed for disposal and replacement.

It is a still further objective of the present invention that is shall be easy to determine the amount of lint and dust which has accumulated on the disposal filter element by observing the interior surface of the filter element surface directly by looking into the transparent end of the device.

It is also a further objective of the present invention that the dryer exhaust tube may be affixed directly to the end of the cylinder that holds the disposable filter element.

Yet still another objective of the present invention is that the filter element cylindrical body and filter element may be mounted either on a wall or set on the floor, without using the rectangular housing. This configuration may be desirable so long as it is the intention of the user to direct the filtered clothes dryer exhaust into the interior of a building only.

### BRIEF DESCRIPTION OF THE DRAWINGS

FIG. 1 is a perspective drawing of the entire assembly, showing the rectangular housing, the filter element assembly cylindrical body, the dryer exhaust inlet and the two outlets.

FIG. 2 is a side view of the cylindrical body showing the dryer exhaust inlet, the framework of the cylindrical body and a portion of the filter element

FIG. 3 is a side view of the cylindrical body without the filter element.

FIG. 4 is a perspective view of the cylindrical body and part of the filter element.

FIG. 5 is a view of the cylindrical body and the filter element shown sitting in the floor without the rectangular housing.

FIG. 6 is a view if the cylindrical housing and filter element attached to a wall without the rectangular housing.

FIG. 7 is an end view of the cylindrical housing showing one set of slots which are used to attach wall brackets or feet for mounting without the rectangular housing.

FIG. 8 is an opposite end view of the cylindrical housing showing one slot which is used to attach wall brackets for mounting without the rectangular housing.

FIG. 9 is a view of one of the feet which are used to set the cylindrical body on the floor without the rectangular housing.

FIG. 10 is a view of the wall mounting bracket used to mount the cylindrical body to the wall without the rectangular housing.

FIG. 11 is a view of the cylindrical body frame without the filter element or the flexible plastic grid material.

FIG. 12 is a view of the plastic grid material shown before being formed around the cylindrical frame.

FIG. 13 is an end view of the rectangular body of the filter assembly showing the circular opening that the cylindrical body fits into.

FIG. 14 is a view of the rectangular housing attached to the wall.

FIG. 15 is a view of the rectangular housing sitting on its end on the floor.

### DETAILED DESCRIPTION OF THE PREFERRED EMBODIMENT

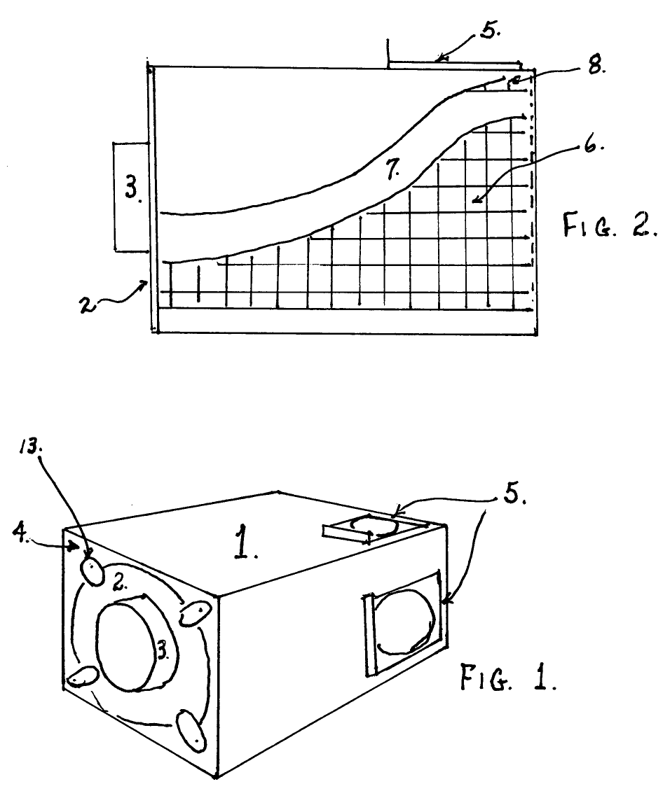

A clothes dryer lint filter device 1 formed in accordance with the present invention is shown in FIG. 1. Its components include, but are not necessarily limited to a rectangular housing 1, and a cylindrical body 14 which includes a disposable filter element. The rectangular housing is currently being fabricated form sheets of acrylic material and glued together, but future production methods of mass production may include plastic injection molding techniques, or other such means as to produce high quality, strength and durability.

A cylindrical body 14 is shown in FIG. 2 which holds a filter element 7 that is wrapped around the cylindrical body 14. The cylindrical body 14 and filter element 7 are shown inserted into the rectangular body 1 and secured with rotating latches.4. The inlet port 3 shown in FIG. I provides a means of connecting a flexible duct from a clothes dryer to the clothes dryer lint filter device. Two outlet ports 5 are shown in FIG. 1. One outlet port may be connected to a flexible duct for directing the filtered dryer exhaust to the exterior of the building. The other outlet port may be used to direct the filtered dryer exhaust to the interior of a building.

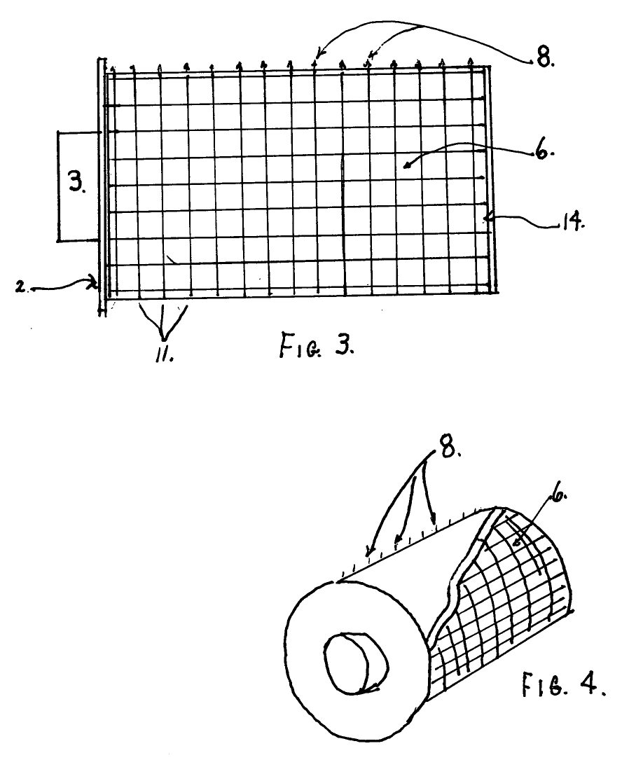

The cylindrical body 14 shown in FIG. 3 is comprised of a plastic grid material obtainable from a variety of sources. The plastic grid material 6 of FIG. 2 is comprised of squares that are approximately 1 inch by 1 inch in size, and is flexible so that it may be formed into a cylinder. The flexible plastic grid 6 is wrapped around the cylindrical body 10 of FIG. 11 and secured in with plastic tie straps 11 shown in FIG.3. Those familiar with the art can appreciate that a variety of other means may be used to secure the plastic grid material to the cylindrical body, such as adhesives, wire or screws. In mass production, the rectangular body and the wire grid may be fabricated entirely using plastic injection molding techniques or other technologies, thus eliminating the need to fabricate and attach the plastic grid material to the cylindrical body entirely.

The cylindrical body 14 of FIG. 3 depicts small wire pins 8 that are that are imbedded into holes in the framework of the cylindrical body 8 of FIG. 4. These pins are used to secure both ends of the disposable filter material 7 to the cylindrical body 14. One end of the filter material 7 is attached over the pins 8 and wrapped around the cylindrical body 14, with the other end also attached over the pins 8 to complete the attachment of the filter material onto the cylindrical body as shown in FIG. 2 and FIG. 4. Those familiar with such devices can envision other means of attaching the filter material 7 to the cylindrical body 14, such as self adhesive strips, rubber bands, or other similar means.

The end plate 2 of FIG. 2 is of a diameter that is slightly larger than the opening 12 of FIG. 13. The cylindrical body 14 of FIG. 4 is inserted into the rectangular housing 1 of FIG. 1. The end plate 2 rests against the end 15 of the rectangular housing 1 of FIG. 1. The cylindrical body assembly 14 of FIG. 4 is secured to the rectangular housing by means of rotating attachment devices 4 that rotate on screws 13 as depicted in FIG. 1. Once the rotating attachment devices 4 of FIG. 1 are closed, the cylindrical body comprised of the framework 10, grid material 6 and filter element 7 is attached securely in place in the rectangular housing. Other means may be used to connect the attachment devices 4 of FIG. 1 to the rectangular housing, such as pins or bolts.

The cylindrical body assembly contains in the other end a metallic duct material 3 of FIG. 4 of a circumference suitable for attachment of a flexible clothes dryer exhaust hose. The flexible clothes dryer exhaust hose may be secured with metal snap rings, tie straps or other similar means that normally are supplied with said flexible clothes dryer exhaust hose.

The outlet ports 5 shown in FIG. 1 are situated in the rectangular housing I of FIG. 1. The design intent is that one outlet port may be closed while the other is open. One of the outlet ports 5 may be open and connected to a second flexible clothes dryer exhaust hose that is directed to the outside of a building. This arrangement may be used in the summer months when it is not desirable to add heat and humidity into the interior of a building. In this case, the second outlet port 5 would be closed. In the winter months, the outlet port 5 connected to the exterior of the building by means of the flexible clothes exhaust dryer would be closed and the other outlet port 5 would be open to allow filtered, warm, moist air into the interior of a building. Those familiar with such contrivances may envision other means of opening and closing the ports 5, such as with rubber plugs, knockouts, or magnetic covers.

The filter material 7 of FIG. 2 will eventually become covered with lint and dust during the normal operation of the clothes dryer machine. Since the clothes dryer filter mechanism of this invention is subsequent to the primary clothes drying machine filter built into the clothes itself, the flexible filter material 7 will not become covered as quickly as the primary filter. When it is evident that a covering of lint and dust has accumulated, as observed through the ends or sides of the filter mechanism, the attachment devices 4 of FIG. 1 are rotated to allow the cylindrical body to be removed from the rectangular housing 1. The used filter element 7 is removed, disposed of and a new filter element 7 is installed, as described is paragraph 4 above.

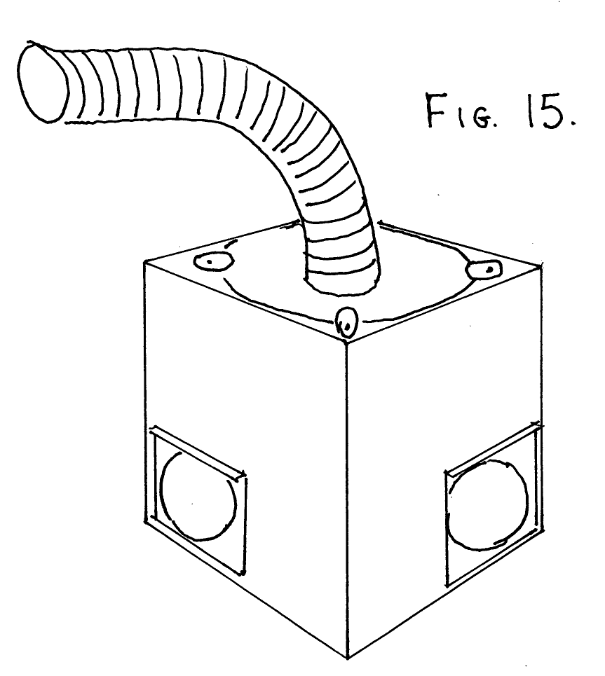

The clothes dryer filter assembly of FIG. 14 is attached to a vertical wall by means of mounting brackets 17 which are attached to the wall by screws, hollow wall anchors, or a multiplicity of other common means. The clothes dryer filter assembly of FIG. 1 is shown in FIG. 15 sitting on its end on the floor. Those whom are familiar with such arrangements can envision other means of mounting, such as on a table or on a shelf

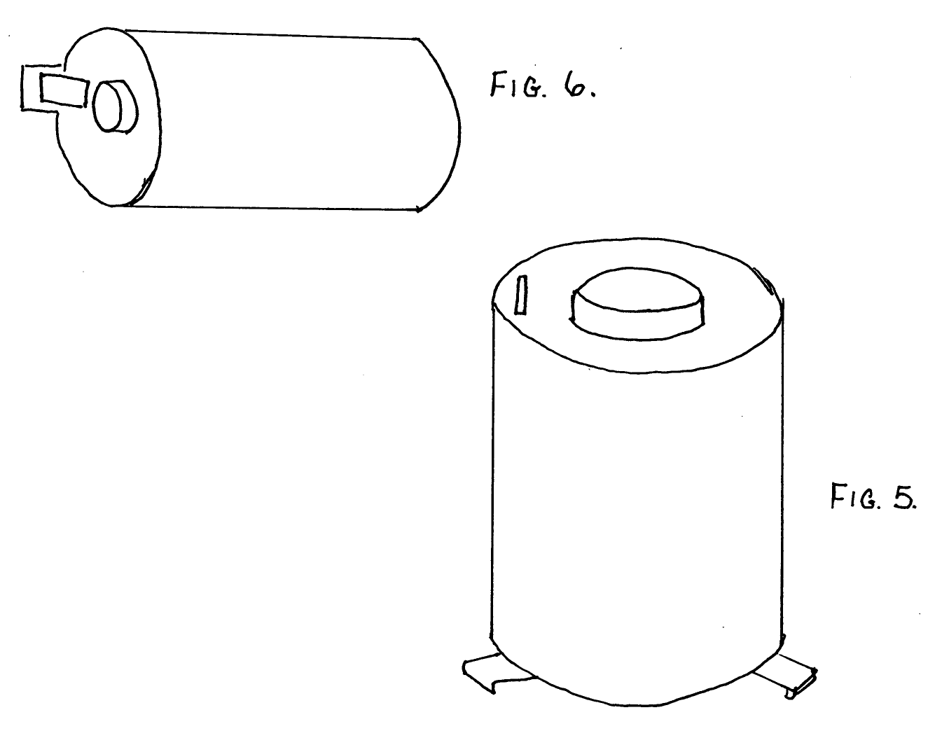

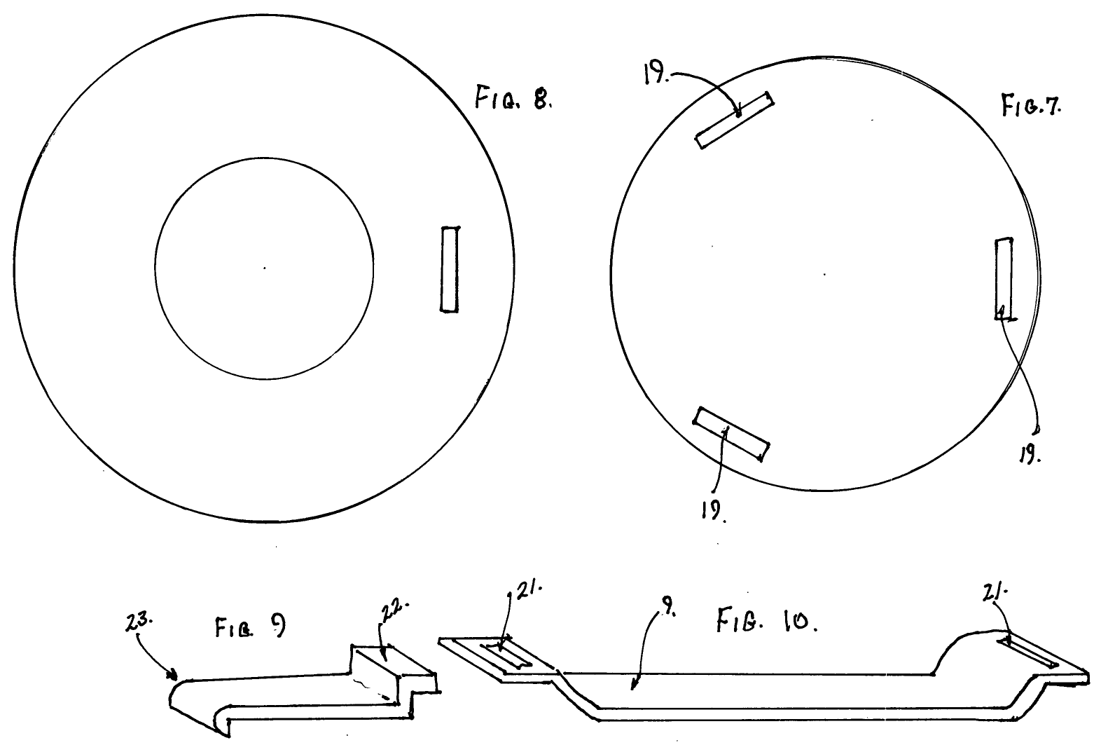

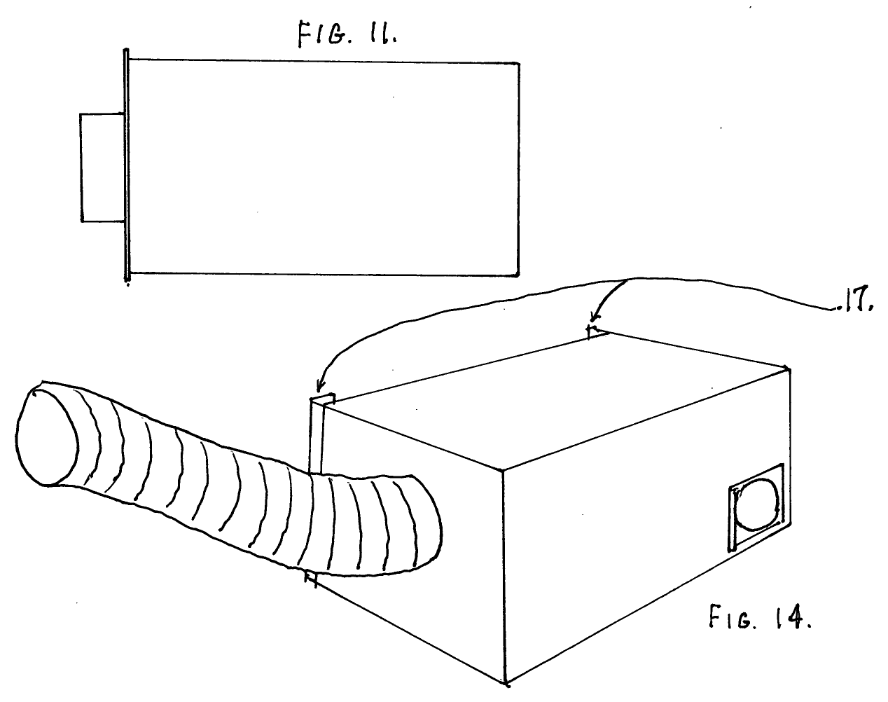

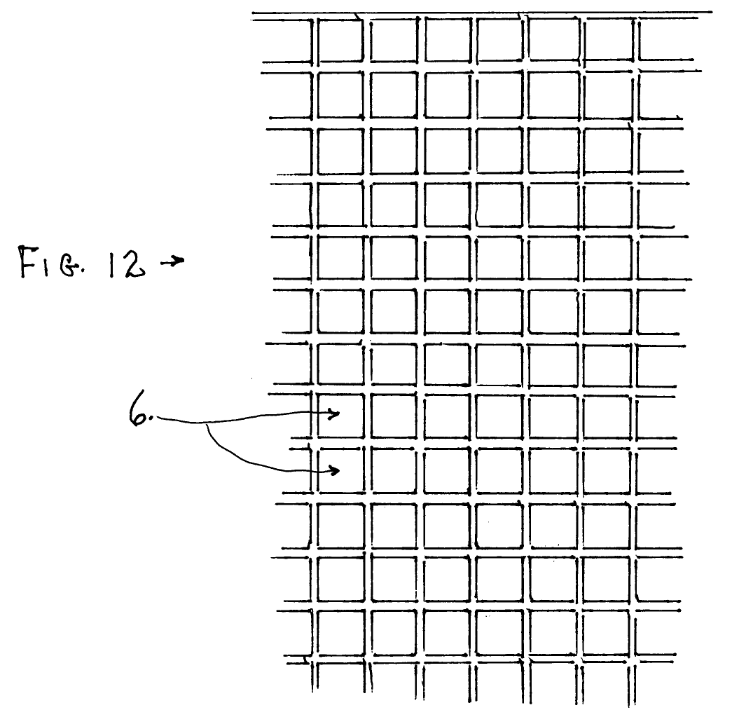

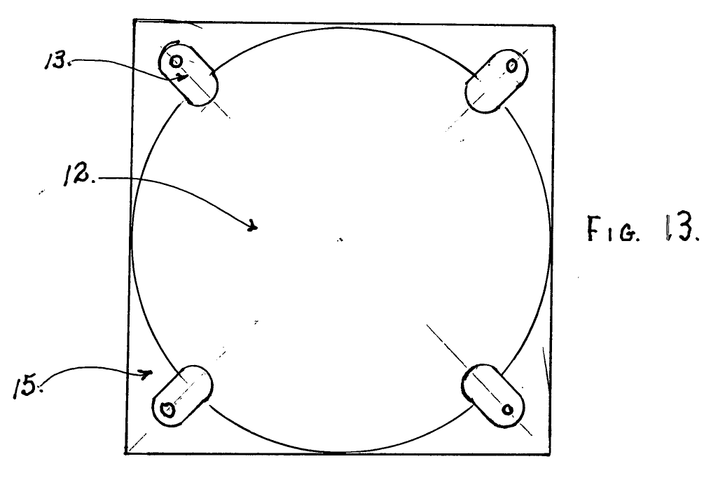

FIG. 5 and FIG. 6 show yet another application of the filter assembly in which the cylindrical body 14 is resting on the floor without using the rectangular housing. Again, in FIG. 6, the cylindrical body 14 is depicted connected to a wall without using the rectangular housing assembly. These applications may be preferable when the filtered, warm, humid air is always intended to be directed into the interior of a building. In such cases, as shown in FIG. 7 and FIG. 8, slots are fashioned into the ends of the cylindrical body 14. These slots provide a place for the clips of FIG. 9 to attach to the cylindrical body 14 by means of one end 22 of the clip, which is inserted into one of the three slots 19 of FIG. 7. This provides a means whereby the cylindrical body 14 shown in FIG. 5 may be placed directly on the floor or another such flat surface. FIG. 6 shows yet another means of attachment such that two of the clips of FIG. 9 are used. One clip is inserted into a slot 20 and 19 into the opposite ends of the cylindrical body. In this embodiment, the mounting bracket of FIG. 10 is connected to a wall using screws, hollow wall anchors or other such similar means. Slots 9 shown in FIG. 10 allows the mounting screws to be attached to the wall surface prior to attaching the bracket of FIG. 10. An end 23 of the clip shown in FIG. 9 is inserted into the slot 21 in the end of the bracket 16 shown in FIG. 10. The radius 18 of FIG. 9 is contrived to allow the legs to fit snugly into slot 19 of FIG. 7. This embodiment allows the cylindrical body to be mounted directly to a wall without the rectangular housing 1. One benefit of this embodiment is that the filter element 7 can be changed without removing the cylindrical body 14 from the rectangular housing 1 and then replacing it.

What is claimed is:

1. A clothes dryer lint filter assembly is developed comprising a rectangular housing with outlet openings and a cylindrical filter assembly that is normally housed within the rectangular housing. This cylindrical filter assembly contains an inlet opening, a plastic grid assembly and a disposable filter assembly.

2. The rectangular housing of claim 1 may be attached to a wall surface, or set on a shelf, table, or other such surfaces. It may also be placed on a floor.

3. The rectangular housing of claim 1 is made of a durable acrylic material, or other similar plastic materials, or other rigid and durable materials so as to be cost effective to manufacture, durable and light in weight.

4. The rectangular housing of claim 1 is attached to a clothes drying machine by means of a readily available flexible hose assembly such as is used to connect the outlet of a clothes drying machine to the outside of a building.

5. The cylindrical body of claim 1 is held inside the rectangular housing of claim 1.

6. The cylindrical body of claim 5 may be removed from the rectangular housing of claim 1 by means of rotating attachment devices to allow the cylindrical body to be removed.

7. The cylindrical body of claim 5 holds a flexible filter element that captures dust and lint that is expelled from the clothes drying machine.

8. The flexible filter element of claim 7 is disposable and easy to install and replace as necessary.

9. The outlet openings of the rectangular housing of claim 1 may be used to direct the filtered, warm moist air to either the interior or exterior of a building.

10. The cylindrical body of claim 5 may be used entirely without the rectangular housing of claim 1 when it is desirable to always have the filtered, warm, moist air directed to the interior of a building.

11. The clothes dryer lint filter assembly of claim 1 does not require a water bath, multiple filter elements or any parts which require movement during the normally intended filtering operation.
